(19) United States
(12) Patent Application Publication
(10) Pub. No.: US 2025/0102694 A1
(43) Pub. Date: Mar. 27, 2025

(54) INTERPOLATION METHOD OF 3D SEISMIC DATA BASED ON MACHINE LEARNING

(71) Applicant: KOREA INSTITUTE OF GEOSCIENCE AND MINERAL RESOURCES, Daejeon (KR)

(72) Inventors: Yonghwan JOO, Daejeon (KR); Daeung YOON, Gwangju (KR)

(21) Appl. No.: 18/895,672

(22) Filed: Sep. 25, 2024

(30) Foreign Application Priority Data
Sep. 25, 2023 (KR) 10-2023-0128328

(51) Int. Cl. G01V 1/32

(52) U.S. Cl. CPC G01V 1/32; G01V 2210/48

(57) ABSTRACT

The present disclosure is an interpolation method of 3D seismic data based on machine learning. The present disclosure has been made to solve the limits and provides an interpolation method for three-dimensional seismic data, capable of performing interpolation for an area where data is not secured based on machine learning using seismic ground truth so that data estimated by interpolation reflects the three-dimensional characteristics of a stratum well.

### CROSS-REFERENCE TO RELATED APPLICATION

This application claims priority to Korean Patent Application No. 10-2023-0128328 filed on Sep. 25, 2023 and all the benefits accruing therefrom under 35 U.S.C. § 119, the contents of which are incorporated by reference in their entirety.

### BACKGROUND

The present disclosure relates to a seismic survey method, and more particularly, to a data processing method of interpolating data for an area where data is not sufficiently secured using seismic data actually acquired in a survey target area.

Seismic survey is a technology that records, using a geophone, reflected or refracted waves of seismic waves artificially generated by a generator back from a stratum to identify the underground stratum structure and the physical properties of sediments and rocks.

The seismic survey is also frequently used for engineering purposes, such as the exploration of underground resources such as oil, natural gas, and gas hydrate, the laying of submarine pipelines and cables, and marine construction projects such as submarine tunnels, submarine storage facilities, and bridges.

The seismic survey is conducted both on land and at sea, and FIG. 1 is intended to describe a marine seismic survey.

Referring to FIG. 1, in the seismic survey, in a state in which a seismic source 3 and a hydrophone 4 are connected to a cable r on a water surface and left floating, a probe 1 conducts survey while towing the seismic source and the hydrophone. As shown in FIG. 1, sound waves are transmitted and received at a point A, and after the probe moves at a set interval (time interval or distance interval) I, sound waves are transmitted and received again at a point B. That is, the seismic source regularly generates sound waves, and the sound waves pass through water L, reflect off a sea bottom S, deeper seabed strata G, or a seabed structure (a cable or the like) and return to the hydrophone 4. Seabed geological structures or the presence or absence of reserves are identified through data processing of received reflected wave signals.

The seismic survey is divided into single-channel survey with only one hydrophone and multi-channel survey with a plurality of hydrophones. The seismic survey may also be divided into 2D survey and 3D survey.

The seismic survey will be described with reference to FIG. 2 and FIG. 3. The two-dimensional (2D) survey is a method of surveying a vertical cross-section (2D) of strata below a probe along a direction of travel (straight line) of the probe by installing only one hydrophone (see FIG. 1, single channel) or a plurality of hydrophones (multi-channel) in a streamer configuration (see FIG. 2) lined up along the direction of travel of the probe. In contrast, the 3D survey surveys a certain volume (3D) of underlying strata as the probe moves by arranging a plurality of hydrophones along a direction perpendicular to the direction of travel of the probe (see a plan view in FIG. 3). When the 2D survey results in one vertical cross-section, in the 3D survey, multiple vertical cross-sections are acquired from each channel in parallel as a result, so that in principle, the cross-sections are combined to form a volume.

In marine seismic survey, by emitting sound waves and receiving reflected waves from a stratum while operating a probe along a set path in a survey target area, data such as a geological structure of the survey area is acquired. However, looking at the acquired data, it may be that there is not enough data for some areas in the entire target area. For example, in the 3D survey, hydrophones are densely arranged in the direction of travel of the probe, but the spacing between streamers is relatively sparse, and thus there are often cases where data for the area between streamers is not secured.

When data for some areas in the entire survey target area is not secured, data interpolation is performed for the areas using data on surrounding areas. However, when using the existing interpolation method in the 3D survey, since the three-dimensional characteristics of the strata are not reflected, there are limits to the accuracy of data values estimated by interpolation.

### SUMMARY

The present disclosure has been made to solve the limits and provides an interpolation method for three-dimensional seismic data, capable of performing interpolation for an area where data is not secured based on machine learning using seismic ground truth so that data estimated by interpolation reflects the three-dimensional characteristics of a stratum well.

Meanwhile, other objects not mentioned in the present disclosure will be additionally considered within the scope to be easily inferred from the following detailed description and effects thereof.

In accordance with an exemplary embodiment of the present disclosure, there is provided an interpolation method for three-dimensional (3D) seismic data based on machine learning in which, in a survey target area in which a plurality of unit areas are formed in a matrix form having a plurality of rows and columns, survey data for unit areas belonging to an even-numbered row is interpolated using seismic data acquired for unit areas belonging to odd-numbered rows, and the interpolation method includes (a) specifying a partial matrix having an odd number of rows and an odd number of columns within the entire matrix of the survey target area, (b) training artificial intelligence by using the survey data for unit areas belonging to odd-numbered columns in odd-numbered rows of the partial matrix as training data and using the survey data for a unit area belonging to an even-numbered column disposed between the unit areas to which the training data belongs as correct answer data, (c) forming a transformation matrix by alternating rows and columns through axis transformation in the partial matrix, and (d) providing the survey data for unit areas belonging to the odd-numbered columns in odd-numbered rows of the transformation matrix as input data to the artificial intelligence and interpolating and generating the survey data for a unit area belonging to an even-numbered column disposed between the unit areas to which the input data belongs.

According to the exemplary embodiment, the interpolation method may further include, after completing (b) to (d) for the partial matrix, newly updating the partial matrix by moving the partial matrix by one or more columns within the entire matrix of the survey target area, and by repeatedly performing (b) to (d) for the updated partial matrix, the survey data may be interpolated and generated for all unit areas belonging to even-numbered rows among rows containing the partial matrix in the survey target area.

In one example of the exemplary embodiment, the interpolation method may further include, after completing (b) to (d) for the partial matrix, newly updating the partial matrix by moving the partial matrix by two or more rows within the entire matrix of the survey target area, and (b) to (d) may be repeatedly performed for the updated partial matrix.

In one example of the exemplary embodiment, the partial matrix may include three rows and three columns, and preferably include five rows and five columns.

### BRIEF DESCRIPTION OF THE DRAWINGS

Exemplary embodiments can be understood in more detail from the following description taken in conjunction with the accompanying drawings, in which:

FIG. 1 is a view for describing principles of seismic survey;

FIGS. 2 and 3 are views for describing a multi-channel method, and are views for comparing a 2D method (FIG. 2, streamer type hydrophone) and a 3D method (FIG. 3);

FIG. 4 shows an example of partitioning a survey area into a plurality of unit areas (bins);

FIG. 5 is a view for describing seismic survey for individual bins within a survey area;

FIG. 6 is a vertical cross-section including line C in FIG. 5, and a view for describing a process by which a reflected signal is recorded at a hydrophone;

FIG. 7 is an example of seismic data;

FIG. 8 is a schematic flow diagram of an interpolation method for machine learning-based three-dimensional (3D) seismic data according to one example of the present disclosure;

FIGS. 9 to 14 are drawings for sequentially describing each process of the interpolation method for seismic data shown in FIG. 8;

FIG. 15 shows a minimum area unit of the interpolation method for survey data according to the present disclosure; and

FIGS. 16 and 17 compare interpolation results using artificial intelligence according to the present disclosure with interpolation results using commercial software and correct answers.

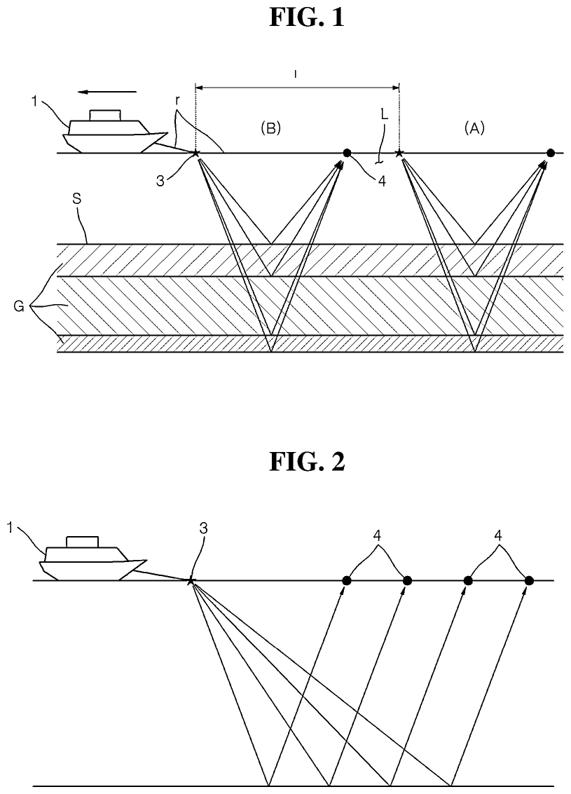

It is clarified that the attached drawings are illustrated as a reference for understanding the technical concept of the present disclosure, and the scope of the present disclosure is not limited by the drawings.

### DETAILED DESCRIPTION OF EMBODIMENTS

In describing the present disclosure, detailed descriptions related to well-known functions and matters obvious to a person skilled in the art will be ruled out when the functions and matters unnecessarily obscures the subject matters of the present disclosure.

To help understand the present disclosure, marine seismic survey will be first described.

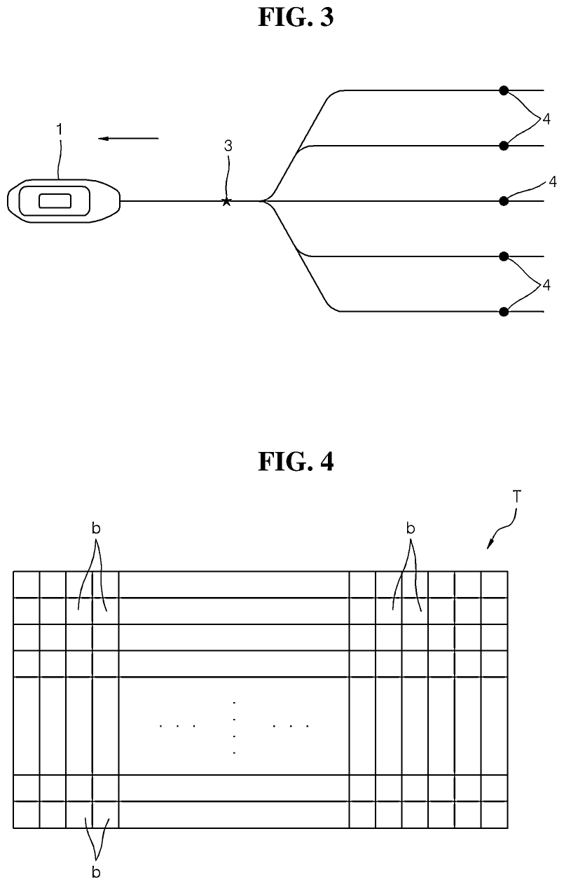

First, survey equipment is prepared. As shown in FIG. 3, a cable r is hung on the back of a probe 1, and a high-frequency seismic source 3 such as a boomer, air gun, sparker, or geological explorer is left floated on the sea. Behind the seismic source 3, a plurality of hydrophones 4 are left floated on the sea at a certain distance apart along a direction perpendicular to a direction of travel of the probe. The probe 1 is equipped with GPS equipment, and the seismic source 3 or the hydrophones 4 may also be equipped with GPS equipment. It is not necessary to install GPS equipment in both the seismic source and the hydrophones, but the GPS equipment may be installed in only some of them. All that is required is to be able to identify the exact location of the seismic source 3 and each hydrophone 4 through the GPS equipment.

As described above, the probe performs seismic survey while moving within a survey area in a state in which the probe is equipped with the seismic source, the hydrophones, a depth gauge, and GPS equipment.

When surveying, first, as shown in FIG. 4, a survey area T is partitioned into a plurality of unit areas (bins mentioned above), and the exact location information about each bin is acquired and input into a controller.

While moving through the survey area along a set survey line (survey path), the probe generates sound waves at regular intervals of time or distance traveled, and receives and records returning reflected waves.

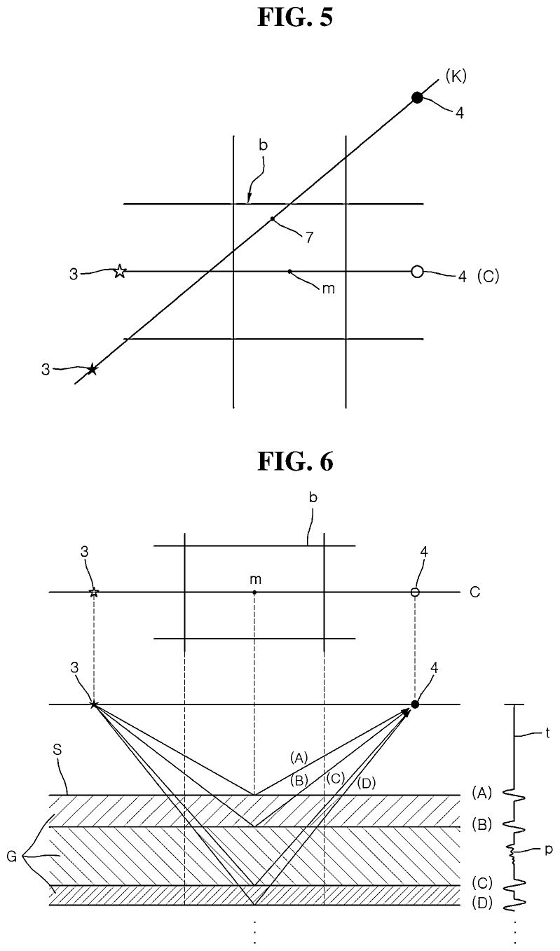

FIG. 5 is a view for describing a process of transmitting and receiving sound waves in seismic survey, and FIG. 6 shows raw data acquired in the seismic survey (hereinafter referred to as “survey data”).

FIG. 5 shows an example (C) in which a vertically long rectangular bin b is displayed in a central portion, and the seismic source 3 and a single hydrophone 4 are respectively arranged on both sides of the bin. The sound waves are reflected and returned at a midpoint (m) between the seismic source 3 and the hydrophone 4. Therefore, when exact locations of the seismic source 3 and the hydrophone 4 are known, it is possible to know from which bin b within the survey area T the sound waves have been reflected. In addition, in FIG. 5, an example (K) is shown where the seismic source and the hydrophone are arranged diagonally with respect to the bin, and in this case, when a location of a midpoint 7 between the seismic source and the hydrophone is known exactly, it is possible to know from which bin b the sound waves have been reflected. It doesn't matter where in the bin the sound waves have been reflected, and the sound waves are all treated as signals for the corresponding bin.

FIG. 6 shows a vertical cross-section of a straight line downward between the seismic source and the hydrophone in the example of (C) of FIG. 5, and the sound waves coming from the seismic source 3 pass through the seawater, are reflected from a sea bottom s and each of strata G and enter the hydrophone 4. The right side of FIG. 6 is data obtained by recording the reflected signals that have entered the hydrophone. The sound waves are first reflected from the sea bottom s and returned, and the sound waves reflected from deeper strata are received with time differences. That is, looking at the data record that is stretched downward (called a trace (t)), a starting point is a point in time when the sound waves have been transmitted, and a time axis progresses downwards. That is, an A signal is first recorded, then data is recorded in the order of B to D signals. Noise p is intermittently recorded. Further, the sound waves from the seismic source are first recorded in the hydrophone in the form of surface waves along the sea surface, and since the sound waves are not signals reflected from the strata, the sound waves are removed from the trace example in FIG. 6.

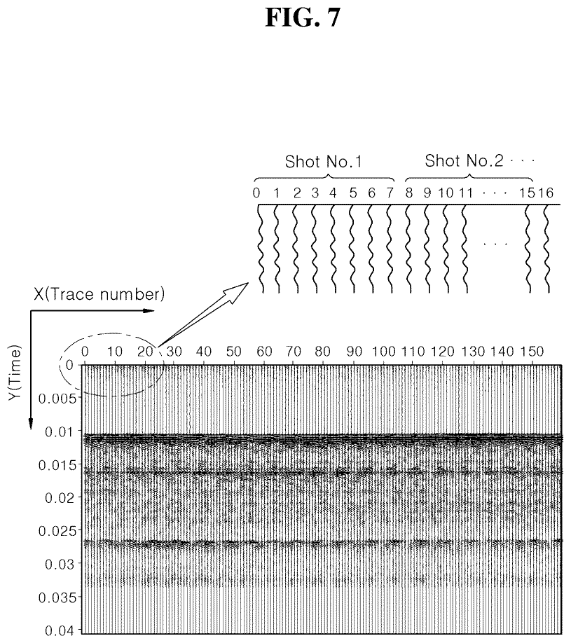

FIG. 7 is survey data in which all traces from the seismic survey are recorded. Referring to FIG. 7, a Y-axis is a time axis (time passes as going down), and an X-axis is a recorded trace number (referred to as a trace number). As in the present example, when eight hydrophones are installed, traces are recorded from each of the eight hydrophones for one sound wave transmission. For example, first eight traces are obtained by recording traces received by each of the eight hydrophones in a first shot (Shot No. 1). In FIG. 7, 20 shots are transmitted and received on each of the eight channels, so a total of 160 traces are recorded.

As described above, the survey data is acquired through the seismic survey on the survey target area. The survey data has to be acquired for all bins partitioned within the target area through the survey, but the survey data may be missing for some bins. This may be especially true in cases where the bins are partitioned as very small areas, such as coastal high-frequency survey. In addition, as shown in FIG. 3, in the case in which the gap between streamers is wide when using a plurality of streamers, it may be structurally difficult to secure survey data for the bins disposed between the streamers. For example, as shown in FIG. 4, when the probe is operated along the X-axis to perform survey in a state in which three streamers are placed on rows 1, 3, and 5 of the survey area T, respectively, the survey data may be missing for the bins for rows 2 and 4.

The present disclosure presents a method for supplementing survey data for bins through machine learning-based interpolation when the survey data for the bins is missing as described above.

It is to be made clear in advance that the present disclosure is entirely carried out by computers and is produced in the form of computer-readable software that is loaded onto and executed by computers.

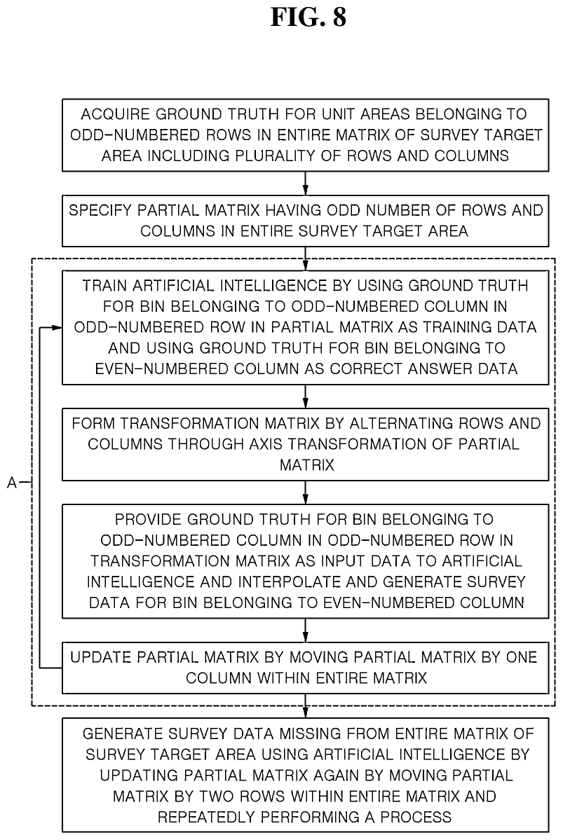

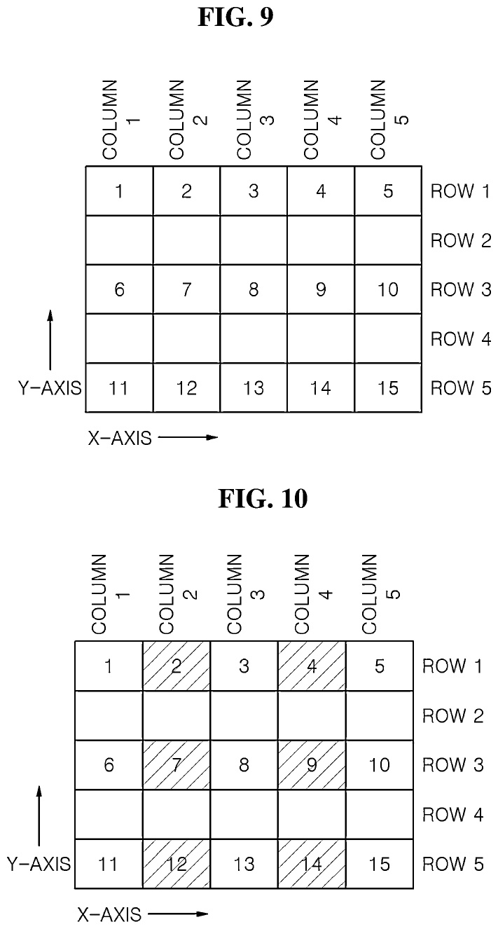

FIG. 8 is a schematic flow diagram of an interpolation method for machine learning-based three-dimensional (3D) seismic data according to one example of the present disclosure. FIG. 9 shows a part (5 rows*5 columns) of the entire survey target area (e.g., 100 rows*100 columns).

In the present disclosure, an interpolation method for survey data is first generated through machine learning.

The entire survey target area includes a plurality of rows and a plurality of columns along an X-axis and a Y-axis, which are perpendicular to each other, forming a plurality of unit areas (bins). The survey target area is in a state in which through seismic survey, ground truth is acquired for unit areas belonging to odd-numbered rows, but ground truth is missing for unit areas belonging to even-numbered rows. In the present disclosure, it is intended to interpolate survey data for unit areas belonging to even-numbered rows in which ground truth is not secured in the survey target area using ground truth.

First, in the present disclosure, a partial matrix is specified within the entire matrix of the survey target area. The partial matrix is contained within the entire matrix and includes an odd number of rows and an odd number of columns. For example, as shown in FIG. 9, the partial matrix may include five rows and five columns, and in its minimum form, may include three rows and three columns. Further, an odd-numbered row and an odd-numbered column in the entire matrix are specified as a first row and a first column in the partial matrix.

As described above, survey data is acquired for the bins belonging to rows 1, 3, and 5, which are spaced apart along the Y-axis in the partial matrix, but survey data is missing for the bins belonging to rows 2 and 4, which are even-numbered rows. The ground truth is expressed in black Arabic numerals for each bin.

Further, in the partial matrix, ground truth for bins belonging to the odd-numbered columns of rows 1, 3, and 5, which are columns 1, 3, and 5, is used as training data for machine learning, and the ground truth for the bins belonging to the even-numbered columns is used as correct answer data. In FIG. 10, for convenience of description, in the ground truth, the correct answer data is shown in hatched between the training data. There are nine pieces of training data and six pieces of correct answer data. Machine learning is performed using nine pieces of training data and six pieces of correct answer data. Using the survey data for nine bins in a partial matrix including 25 bins as training data, training is conducted to generate six pieces of survey data between pieces of the survey data for nine bins through interpolation.

The important point here is that the training is conducted by area unit. In the case of interpolation by artificial intelligence in the related art, the training is conducted by line unit. That is, the existing method is to generate second data using first training data and third training data, or to generate ninth data and eleventh data using eighth data, tenth data, and twelfth data. However, the method has limitations in increasing the reliability of interpolated data since it does not reflect data on a surrounding area. On the other hand, in the present disclosure, since interpolation is performed using data on both sides and left and right of the corresponding bin, that is, data from a certain area around the corresponding bin, compared to the existing method that only uses data on bins on both sides of a line passing through the corresponding bin, reliable results may be obtained. Here, “certain area” more precisely means 3D rather than 2D, that is, “certain space (volume)”. The ground truth for each bin reflects information about depth as shown in FIG. 6, resulting in a 3D volume.

In summary, the present disclosure is characterized by using survey data acquired within a certain space as training data for training artificial intelligence and training the artificial intelligence to generate data for areas (bins) where survey data is missing within the corresponding space. In the present example, the artificial intelligence is trained using nine pieces of training data and six pieces of correct answer data in a space with 5*5, that is, 25 bins. For reference, as the artificial intelligence, commercial artificial intelligence that is widely used in the relevant technical field may be used and artificial intelligence itself may be of various types, which is a well-known concept in the relevant technical field, so a detailed description thereof will be omitted.

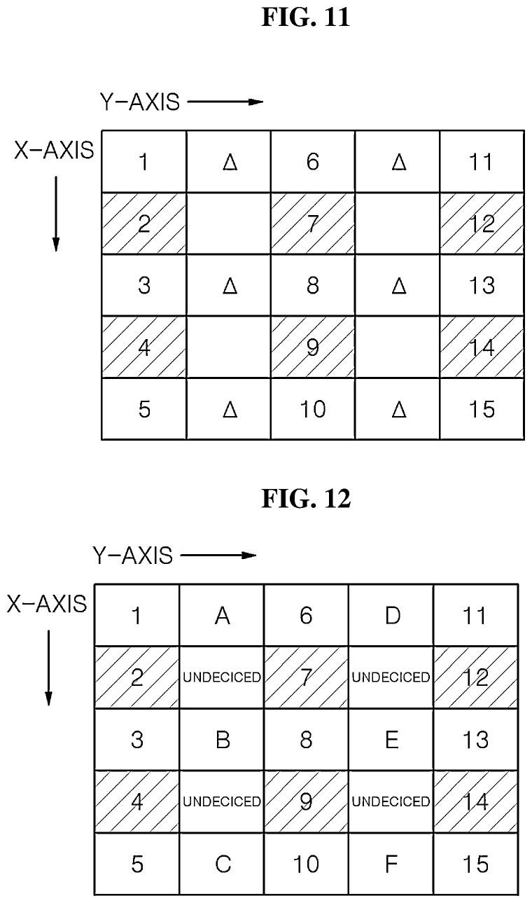

Now, using the artificial intelligence trained in the above-mentioned manner, interpolation is performed for areas where ground truth is not obtained in the survey, and the X-axis and Y-axis of the partial matrix are transformed as shown in FIG. 11. After transforming the axes in this way, locations of bins on which no survey data is acquired are placed in locations (triangles) where the correct answer data is placed when training the artificial intelligence before. The location where the correct answer data is placed is ultimately the location where data has to be generated by the artificial intelligence.

After the axis transformation, as shown in FIG. 12, the ground truth (1, 3, 5, 6, 8, 10, 11, 13, 15) for nine bins arranged in odd-numbered columns (column 1, column 3, column 5) in each of odd-numbered rows (row 1, row 3, row 5) among 25 bins of the partial matrix are provided as input data to the artificial intelligence. Based on the input data, the trained artificial intelligence generates data (A to F) for each bin belonging to even-numbered rows between the input data.

After going through the aforementioned process, as shown in FIG. 12, six bins for which ground truth is not secured were generated, and only four bins are left without survey data. In FIG. 12, the corresponding bins are marked as “undecided.”

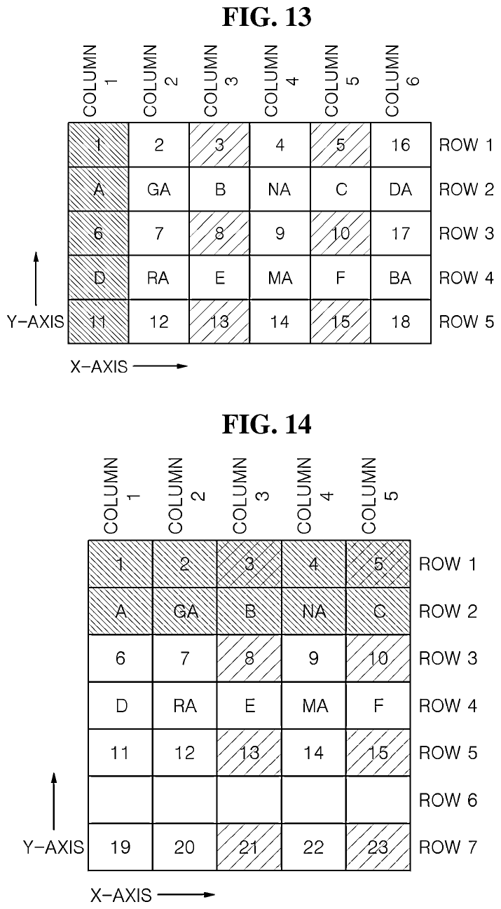

In order to generate data for the four bins using the artificial intelligence, it is required to go back to the previous operations and perform the same process. However, the partial matrix needs to be updated. That is, the partial matrix is newly updated by moving it by one column within the entire matrix, that is, moving it by one column in an X-axis direction. Then, it is required to perform the same process as described above. Referring to FIG. 13, the bins arranged in column 1 have three pieces of ground truth (1, 6, 11) and data (A, D) on two bins generated by the artificial intelligence, so all data have been secured for the bins belonging to column 1, and thus, column 1 is excluded, the column is moved by one space, so that five columns from columns 2 to 6 are considered again. The rows remain as they are, rows 1 to 5. Looking at the entire matrix, the partial matrix is updated as a 5*5 matrix with rows 1 to 5 and columns 2 to 6.

When repeating the process described above on the partial matrix updated as a 5*5 matrix with rows 1 to 5 and columns 2 to 6, data (GA, NA, DA, RA, MA, BA) for the bins arranged in columns 2, 4, and 6 of rows 2 and 4 may be generated using the artificial intelligence.

For example, when the survey target area has 100 columns along the X-axis, by repeating the aforementioned process while moving the partial matrix by one column at a time, it is possible to generate data for bins belonging to rows 2 and 4 where ground truth is not secured from bins belonging to rows 1 to 5. Meanwhile, when moving the partial matrix by one more column in the state of FIG. 13 and then performing the same process, another data is generated for bins marked B, C, E, and F. In particular, in bins marked C and F, three pieces of data are generated each. In cases where data is generated in duplicate in this way, the data may be confirmed through follow-up processing such as merging or averaging the duplicate data (traces).

As described above, once data is acquired from bins belonging to all columns in rows 1 to 5 along the X-axis in the survey area, the aforementioned process is repeated while moving through rows along the Y-axis. When moving along the X-axis, the partial matrix is moved by one column at a time, while when moving along the Y-axis, the partial matrix is moved by two rows at a time as shown in FIG. 14 to update the partial matrix, and then the aforementioned process is performed. As shown in FIG. 14, by performing the same process as above for the partial matrix updated with five rows (rows 3 to 7) and five columns (columns 1 to 5), all data for the entire 100 columns of the survey area for rows 3 to 7 may be acquired.

In the same way as above, data may be generated through the artificial intelligence for bins where ground truth is not secured in the survey target area including, for example, 100 rows and 100 columns. Data is mainly generated by mathematical interpolation methods in the related art, but in the present disclosure, data is generated using the artificial intelligence, and in particular, since the artificial intelligence is trained in units of a certain volume of the target area, there is an advantage in that data from the surrounding area is faithfully reflected, allowing for the generation of highly reliable data.

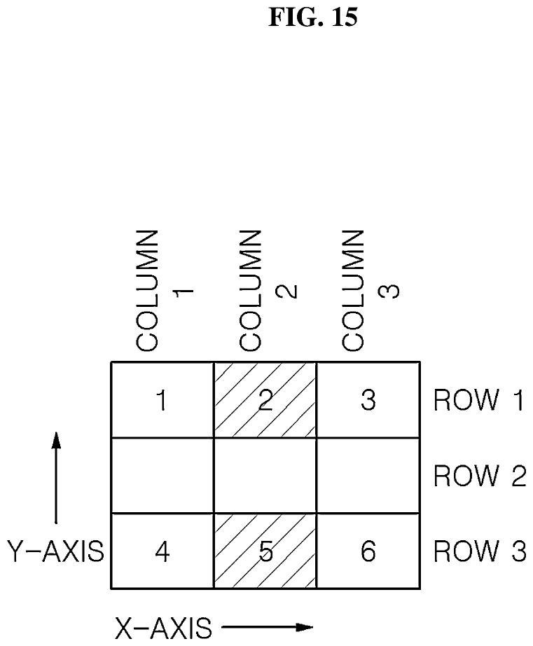

Meanwhile, so far, the example has been described where, among 25 bins in five rows and five columns, the bins belonging to rows 1, 3, and 5 all have ground truth while the bins belonging to rows 2 and 4 have no data. However, the present disclosure is characterized in that, when training artificial intelligence, rather than using data on bins arranged in a row as training data, data on bins belonging to a certain volume (area) is used as training data. Therefore, in the present disclosure, the minimum unit may be 3 rows and 3 columns. That is, as in FIG. 15, even when data for a total of six bins in columns 1 to 3 of each of rows 1 and 3 are actually measured and data is missing for bins belonging to row 2, the aforementioned process may be repeated in the same manner. In this case, the artificial intelligence is trained using the ground truth on the bins belonging to columns 1 and 3 as training data, and using the ground truth in column 2 as correct answer data. In addition, through axis transformation, data for the bins that originally belong to row 2 may be generated, and through the process of moving along the X-axis and moving along the Y-axis, data for the entire bins of the survey target area may be acquired.

As described above, in the present disclosure, by training artificial intelligence using survey ground truth as training data and correct answer data, it is possible to supplement data for areas where ground truth is not secured among survey target areas. In particular, in the present disclosure, by training artificial intelligence using data on a surrounding 3D area of a bin to be supplemented as training data, there is an advantage in that highly reliable data that accurately reflects the surrounding terrain, strata conditions, and the like, can be secured.

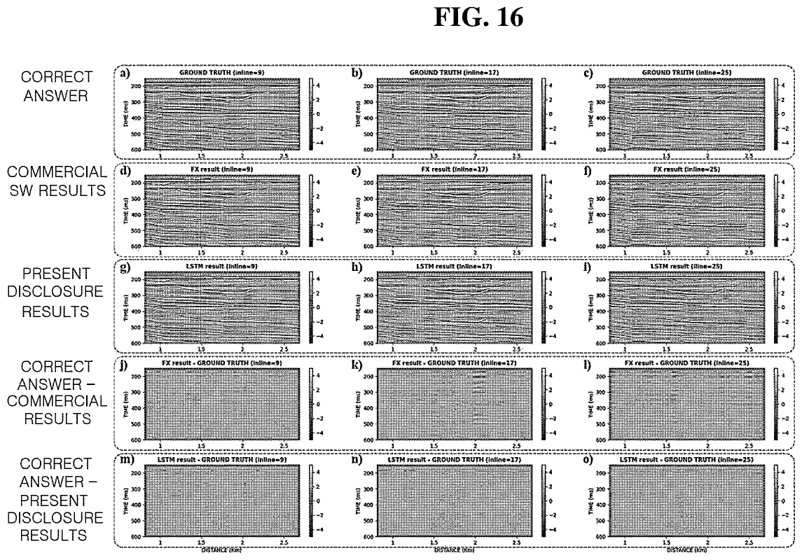

FIG. 16 shows, in order, ground truth (correct answers), results of interpolation using commercial software (SW) used for data interpolation in the related art, and results of data generation by artificial intelligence trained based on volume according to the present disclosure, and shows an example of comparing the correct answers with the commercial results and comparing the correct answers with the results according to the present disclosure. The interpolation results obtained using the present disclosure show a similar tendency to the interpolation results obtained using commercial SW. However, it can be seen that, looking at [Correct Answer-Commercial Results], in the case of results using commercial software, low-frequency noise occurs as in j) to l) depending on parameter selection, but referring to [Correct Answer-Present disclosure Results], the results according to the present disclosure do not cause low-frequency noise and are therefore more accurate.

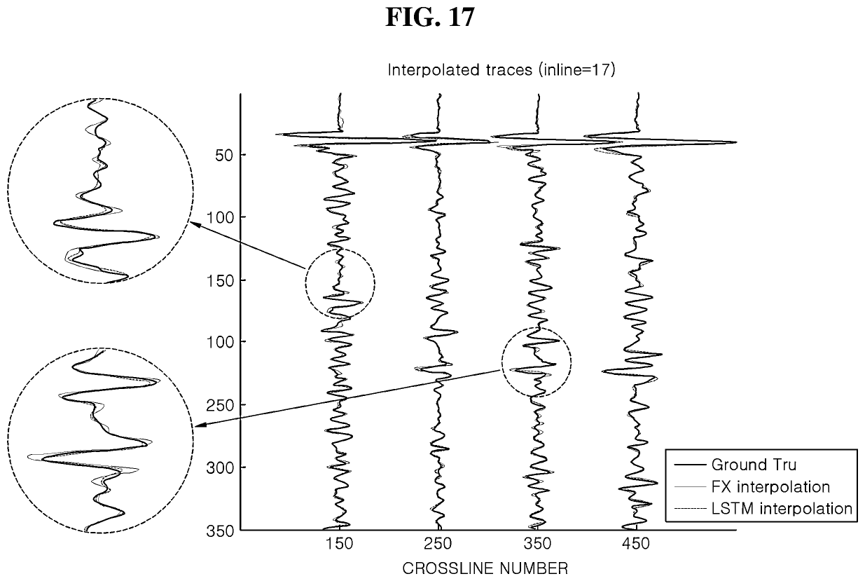

FIG. 17 shows correct answer traces (Ground Tru), interpolation results using commercial software (FX interpolation), and interpolation results using artificial intelligence according to the present disclosure (LSTM interpolation). When looking at enlarged traces, it is confirmed that the interpolated results according to the present disclosure are relatively closer to the correct answers than the results using existing commercial software when compared with an actual signal (Ground Tru) at interpolation locations.

In the present disclosure, by training artificial intelligence using ground truth as training data and correct answer data, it is possible to supplement data for areas where ground truth is not secured among survey target areas. In particular, in the present disclosure, by training artificial intelligence using data on a surrounding 3D area of a bin to be supplemented as training data, there is an advantage in that highly reliable data that accurately reflects the surrounding terrain, strata conditions, and the like, can be secured.

Meanwhile, even though an effect is not specifically described herein, the effect described in the description below and expected by the technical feature of the present disclosure and a temporary effect thereof will be considered as being described in the specification of the present disclosure.

The scope of the present disclosure is not limited by the examples and descriptions specifically described so far. Furthermore, it is stated once more that the scope of the present disclosure should not be construed to be limited by an obvious change or a substitution in the field to which the present disclosure pertains.

What is claimed is:

1. An interpolation method for three-dimensional (3D) seismic data based on machine learning in which, in a survey target area in which a plurality of unit areas are formed in a matrix form having a plurality of rows and columns, survey data for unit areas belonging to an even-numbered row is interpolated using seismic data acquired for unit areas belonging to odd-numbered rows, the interpolation method comprising:
(a) specifying a partial matrix having an odd number of rows and an odd number of columns within the entire matrix of the survey target area;
(b) training artificial intelligence by using the survey data for unit areas belonging to odd-numbered columns in odd-numbered rows of the partial matrix as training data and using the survey data for a unit area belonging to an even-numbered column disposed between the unit areas to which the training data belongs as correct answer data;
(c) forming a transformation matrix by alternating rows and columns through axis transformation in the partial matrix; and
(d) providing the survey data for unit areas belonging to the odd-numbered columns in odd-numbered rows of the transformation matrix as input data to the artificial intelligence and interpolating and generating the survey data for a unit area belonging to an even-numbered column disposed between the unit areas to which the input data belongs.

2. The interpolation method of claim 1, further comprising, after completing (b) to (d) for the partial matrix, newly updating the partial matrix by moving the partial matrix by one or more columns within the entire matrix of the survey target area,
wherein, by repeatedly performing (b) to (d) for the updated partial matrix, the survey data is interpolated and generated for all unit areas belonging to even-numbered rows among rows containing the partial matrix in the survey target area.

3. The interpolation method of claim 1, further comprising, after completing (b) to (d) for the partial matrix, newly updating the partial matrix by moving the partial matrix by two or more rows within the entire matrix of the survey target area,
wherein (b) to (d) are repeatedly performed for the updated partial matrix.

4. The interpolation method of claim 1, wherein the partial matrix includes five rows and five columns.
